(19) United States
(12) Patent Application Publication
(10) Pub. No.: US 2009/0101037 A1
(43) Pub. Date: Apr. 23, 2009

(54) GAP MEASURING METHOD, IMPRINT METHOD, AND IMPRINT APPARATUS

(75) Inventors: Nobuhito Suehira, Kawasaki-shi (JP); Junichi Seki, Yokohama-shi (JP); Yukio Furukawa, Palo Alto, CA (US); Hideki Ina, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/997,491

(22) PCT Filed: May 30, 2007
(86) PCT No.: PCT/JP2007/061401

§ 371 Date: Jan. 31, 2008

(30) Foreign Application Priority Data
May 31, 2006 (JP) 2006-151023

(51) Int. Cl. B41F 1/54; G01B 11/14

(52) U.S. Cl. 101/484; 356/625

(57) ABSTRACT

A gap measuring method for measuring a gap between two members by irradiating the two members with light is constituted by preparing a first member and a second member which are disposed opposite to each other; irradiating the first member and the second member with light from one member side to obtain spectral data about intensity of reflected light or transmitted light from the other member side; and determining a gap between the first member and the second member by comparing the obtained spectral data with a database in which a gap length and an intensity spectrum are correlated with each other.

### TECHNICAL FIELD

The present invention relates to a gap measuring method an imprint method, and an imprint apparatus.

### BACKGROUND ART

In recent years, as proposed in Appl. Phys. Lett., Vol. 67, Issue 21, pp. 3114-3116 (1995) by Stephan Y. Chou et al., a fine processing technology for transferring a fine structure provided to a mold onto a resin material on a substrate has been developed and has received attention. This technology is called nanoimprint or nanoembossing since it has resolving power on the order of several nanometers. By utilizing this technology, it is possible to collectively process a three-dimensional structure at a wafer level, in addition to semiconductor fabrication. For this reason, the technology has been expected to be applied to not only processing of a semiconductor substrate but also a wide variety of fields including production technologies of optical devices such as photonic crystal, and biochips such as μ-TAS (Micro Total Analysis System).

The case where a technology which is called a light imprint method is used in a semiconductor fabrication technology or the like will be described.

First, on a substrate (e.g., a semiconductor wafer), a layer of photocurable resin material is formed.

Then, the mold on which a desired imprint structure is formed is pressed against the resin material layer, followed by irradiation with ultraviolet rays to cure the resin material. As a result, the imprint structure is transferred onto the resin material layer.

Thereafter, etching or the like is effected by using the resin material layer as a mask, whereby the imprint structure of the mold is transferred onto the substrate.

Next, the reason why measurement of a gap between the mold and the substrate is significant in such a nanoimprint technology will be described.

During an imprint operation, it is desirable that there is no gap between the mold and the substrate, i.e., the mold and the substrate completely contact each other. This corresponds to that a (photo-)resist at an unnecessary portion may desirably be completely removed after development in a conventional light exposure device.

However, in the nanoimprint technology, it is difficult to ensure the above described complete contact between the mold and the substrate, so that a layer which is called a residual film layer remains.

When the imprint operation is performed in a state of no gap control, an irregularity in thickness of the residual film (layer) occurs between a plurality of substrates in a simultaneous (collective) transfer method. Further, in a step-and-repeat method in which the imprint operation is performed plural times on one substrate while an imprint position is changed, an irregularity in thickness of the residual film occurs between chips formed in a single imprint operation.

In the imprint method, as described above, the substrate is subjected to etching by using the resin material layer as a mask. An etching time is constant, so that when irregularities in projections and recesses and a shape of a structure to be transferred onto the substrate also occur between substrates and chips when there is the irregularity in thickness of the residual film. These irregularities significantly and adversely affect a yield of a device. In order to effect control of the gap between the mold and the substrate, it is necessary to perform measurement of the gap.

In order to measure a gap between two members, there has been proposed a method in which the two members are irradiated with light from one member side at a wavelength of a measurement light source. However, in this method, it is difficult to measure a gap of not more than ¼ of the measurement light source wavelength.

In order to solve this problem, U.S. Pat. No. 6,696,220 has proposed a gap measuring method for measuring a gap between a mold and a substrate, wherein a first surface (processing surface) close to the substrate and a second surface spaced apart from the substrate are provided to the mold and a gap between the second surface and a second surface is measured.

In this method, during the measurement, the mold having a thickness, between the first surface and the second surface, of not less than ¼ of the wavelength of the light source for measurement is utilized.

However, the gap measuring method proposed in U.S. Pat. No. 6,696,220 is not necessarily satisfactory but involves the following problem.

Projections and recesses of a transfer pattern at the processing (first) surface of the mold and the stepped portions between the processing surface and the second surface do not necessarily coincide with each other.

A step of preparing the mold having such a plurality of the stepped portions is complicated. Further, it is necessary to accurately measure the stepped portions for measuring the gap. Particularly, in the case where a very small gap length (e.g., of not more than ¼ of the measurement light source wavelength) is measured with high accuracy, it is necessary to form the above described stepped portions per se with high accuracy.

### DISCLOSURE OF THE INVENTION

In view of the above described problems, a principal object of the present invention is to provide a gap measuring method having solved the problems.

Another object of the present invention is to provide an imprint apparatus and an imprint method which have solved the problems.

According to an aspect of the present invention is to provide a gap measuring method for measuring a gap between two members by irradiating the two members with light, the gap measuring method comprising:

preparing a first member and a second member which are disposed opposite to each other;

irradiating the first member and the second member with light from one member side to obtain spectral data about intensity of reflected light or transmitted light from the other member side; and

determining a gap between the first member and the second member by comparing the obtained spectral data with a database in which a gap length and an intensity spectrum are correlated with each other.

According to another aspect of the present invention, there is provided an imprint method for forming a pattern by interposing a pattern forming material between two members and curing the pattern forming material, the imprint method comprising:

preparing a first member having an imprint pattern at a surface thereof;

preparing a second member disposed opposite to the first member;

measuring a gap between the first member and the second member by the gap measuring method described above;

decreasing the gap between the first member and the second member until a difference between a gap length measured by the gap measuring method and a preset gap length is within an acceptable error range; and

curing the pattern forming material interposed between the first member and the second member in a state in which the difference between the gap length measured by the gap measuring method and the preset gap length is within the acceptable error range.

According to a further aspect of the present invention, there is provided an imprint apparatus for transferring a pattern formed on a processing surface of a mold onto a member to be processed, the imprint apparatus comprising:

physical amount measuring means for measuring a physical amount varying depending on a distance between the mold and the member to be processed; and

distance estimating means for estimating the distance between the mold and the member to be processed by comparing the measured physical amount with data preliminarily stored in a database.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a flow chart for illustrating the gap measuring method according to the present invention.

FIG. 2 is a flow chart for illustrating the imprint method according to the present invention.

FIG. 3 is a schematic view showing a constitution of a processing apparatus (imprint apparatus) used in Embodiment 1 of the present invention.

FIGS. 4(a) and 4(b) are schematic views for illustrating a distance estimating method in Embodiment 1 of the present invention, wherein FIG. 4(a) shows an obtained spectrum and FIG. 4(b) shows a database.

FIG. 5 is a flow chart for illustrating a distance control procedure in Embodiment 1 of the present invention.

FIGS. 6(a) and 6(b) are schematic views for illustrating a distance estimating method in Embodiment 2 of the present invention, wherein FIG. 6(a) shows an obtained spectrum and reference data and FIG. 6(b) shows a database for extreme values and reference data.

FIG. 7 is a flow chart for illustrating a distance control procedure in Embodiment 2 of the present invention.

### BEST MODE FOR CARRYING OUT THE INVENTION

### First Embodiment

### Gap Measuring Method

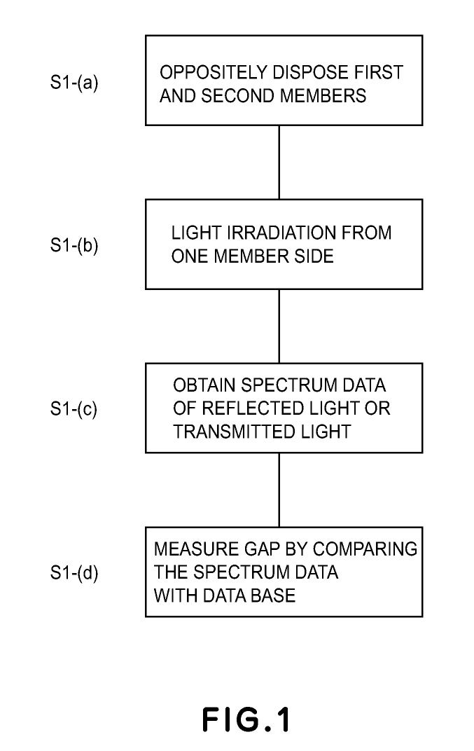

A gap measuring method for measuring a gap between two members by irradiating the members with light according to the present invention will be described with reference to FIG. 1.

Referring to FIG. 1, first, a first member and a second member which are disposed opposite to each other are prepared (S1-(a)).

Next, the first and second members are irradiated with light from one of the first member side and the second member side to obtain spectral data about an intensity of reflected light from the other member side or transmitted light from the other member side with respect to the irradiation light (S1-(b)). For example, the other member may be a substrate. The spectral data may be obtained within a wavelength range of a light source for measurement. Details thereof will be described later.

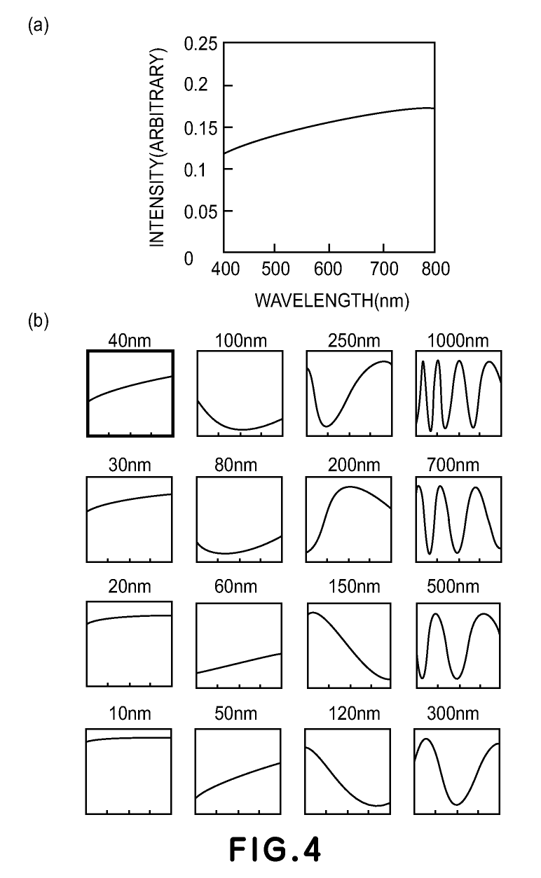

Then, the gap between the first member and the second member is measured by comparing the obtained spectral data with a database in which a gap length and an intensity spectrum are correlated with each other (S1-(c)). The spectral data about the intensity may be intensity spectral data for reflected light as described later with reference to FIG. 4(a) and may also be intensity spectral data for transmitted light when the transmitted light is measurable.

Further, the spectral data about the intensity is not particularly limited so long as it is possible to estimate a gap length by comparison with the database. The spectral data about the intensity may be not only continuously changing data as shown in FIG. 4(a) but also intensity data at a predetermined wavelength or slope (inclination) data about a difference in intensity spectrum between two measurement wavelengths.

Data stored in the database are collected in advance by simulation or actual measurement. Information stored in the database may be continuously changing data as shown in FIG. 4(b), intensity data at a predetermined wavelength or a plurality of predetermined wavelengths, or slope data about a difference in intensity spectrum between two measurement wavelengths.

The above described gap measuring method may preferably be applied when the gap length is not more than ¼ of the measurement light source wavelength. It is also possible to measure the gap through the comparison with the database in the case where the gap length is not less than ¼ of the measurement light source wavelength.

The gap measuring method in this embodiment is applicable to not only an imprint apparatus described later but also various apparatuses, requiring measurement of a gap on the order of several tens of nanometers, such as a bonding apparatus and an alignment apparatus.

A physical amount to be measured may be not only an amount of light but also those of a force, electricity, magnetism, etc. The amount of the force is measured by a load cell or the like. The amount of electricity is measured by electrostatic capacity or the like. The amount of magnetism is measured by a hole device or the like.

### Second Embodiment

### Imprint Method

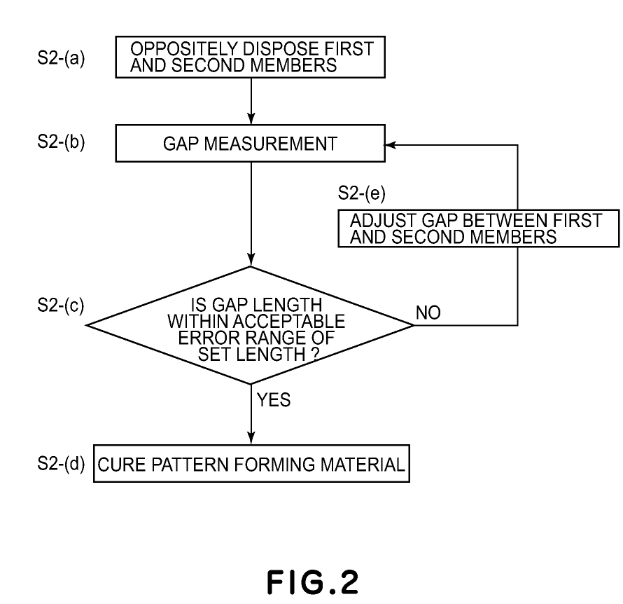

Next, the imprint method according to the present invention will be described with reference to FIG. 2. More specifically, the imprint method relates to such an imprint method that a pattern forming material is interposed between two members and is cured to form a pattern.

Referring to FIG. 2, first, a first member having an imprint pattern at its surface and a second member disposed opposite to the first member are prepared (S2-(a)).

Then, a gap between the first member and the second member is measured by the gap measuring method described in First Embodiment (S2-(b)).

The gap between the first member and the second member is adjusted until a difference between a gap length obtained by the measurement and a preset gap length is within an acceptable error range of the preset gap length (S2-(c) and S2-(e)).

When the difference is out of the acceptable error range, the gap between the first member and the second member is decreased or increased.

In a state in which the difference between the preset gap length and the gap between the first member and the second member is within the acceptable error range, the pattern forming material interposed between the first member and the second member is cured (S2-(d)).

Thus, in a state in which the gap is strictly adjusted, it is possible to transfer the imprint pattern provided to the first member onto the pattern forming material.

Into the imprint method according to the present invention, it is also possible to incorporate two types of gap measuring methods. For example, in the case where the gap length can be estimated by Fourier transform or the like of spectral data per se of reflected light intensity, the gap length is directly estimated from the spectral data. In this case, it is also possible to employ a known method instead of the Fourier transform. In the case where the gap length is not more than a predetermined gap length (e.g., not more than ¼ of the measurement light source wavelength), the gap measuring method is switched to the above described gap measuring method based on the comparison with the database.

A: First Member (Mold)

A mold as the first member is constituted by materials of glass such as quartz or the like, metal, silicon, etc. The imprint pattern provided to the processing surface of the mold is formed, e.g., by electron beam lithography. Incidentally, after a release agent is applied onto the imprint pattern provided to the mold, it is also possible to indirectly contact the second member and the mold via the release agent.

Further, an alignment mark provided to the mold is ordinarily formed by an imprint structure comprising projections and recesses. However, in the case where the mold constituting material and the pattern forming material (resin material) have refractive indices which are close to each other, the alignment mark is less visible in some cases when the resin material and the mold contact each other. In order to obviate this phenomenon, a high refractive index material such as SiN may preferably be provided at a surface of, e.g., a quartz-made mold in an alignment mark area.

B: Second Member (Substrate or Wafer)

As the second member, it is possible to use an Si substrate, a semiconductor substrate such as GaAs substrate, a resin substrate, a quartz substrate, a glass substrate, etc.

C: Pattern Forming Material

In order to curve the resin material as the pattern forming material applied onto the substrate, e.g., the resin material is irradiated with, e.g., ultraviolet rays from the mold side. Examples of such a photocurable resin material may include those of urethane-type, epoxy-type, acrylic-type, etc. It is also possible to use a thermosetting resin material such as a phenolic resin, an epoxy resin, a silicone resin, or a polyimide resin, and a thermoplastic resin material such as a polymethyl methacrylate (PMMA) resin, a polycarbonate (PC) resin, a polyethylene terephthalate (PET) resin, or an acrylic resin.

The imprint pattern is transferred by effecting heating treatment as desired.

The imprint method of this embodiment includes a light imprint method and a thermal imprint method.

In the case where the member to be processed is constituted with no resin material, the member to be processed is physically transformed by only a pressing force.

Further, the above described imprint method also includes the case where the pattern forming material such as the photocurable resin material is not interposed between the first member and the second member, i.e., the case where the imprint pattern provided to the first member is directly transferred onto the second member.

### Third Embodiment

### Imprint Apparatus

An imprint apparatus according to this embodiment is such an imprint apparatus that a pattern formed at a processing surface of a mold is transferred not a member to be processed.

More specifically, the imprint apparatus includes a physical amount measuring means for measuring a physical amount varying depending on a distance between the mold and the member to be processed. The imprint apparatus further includes a distance estimating means for estimating the distance between the mold and the member to be processed by comparing the measured physical amount with data stored in a database in advance.

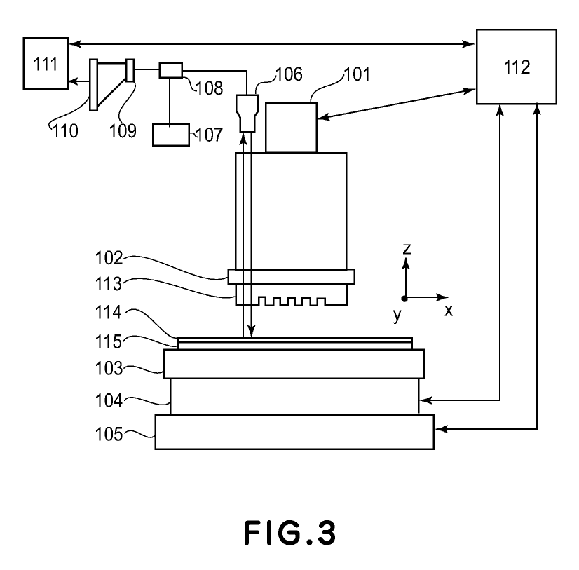

FIG. 3 is a schematic view as an example of the imprint apparatus according to the present invention.

Referring to FIG. 3, the imprint apparatus of the present invention includes an exposure light source 101, a mold holding portion 102, a substrate holding portion 103, a substrate raising and lowering mechanism 104, an in-plane moving mechanism 105, an optical system 106, a measurement light source 107, a beam splitter 108, a spectroscope 109, an image pickup device 110 such as a charge-coupled device (CCD), an analyzing mechanism 111, an imprint controlling mechanism 112, a mold (template) 113, a photocurable resin material 114, and a substrate 115. These constituent members for the imprint apparatus will be described more specifically in Embodiment 1 appearing hereinafter.

In this embodiment, as a processing apparatus, an imprint apparatus including a mold holding means, a substrate holding means, a substrate raising and lowering means, an in-plane moving mechanism for the substrate, and the like is used.

Further, the processing apparatus can be constituted so as to estimate a distance between the mold and the member to be processed by a combination of a means for measuring a physical amount varying depending on the distance with a means for comparing the measured physical amount with a database.

Further, it is possible to measure the gap between the mold and the substrate regardless of the presence or absence of stepped portions of the mold by estimating the distance between the mold and the member to be processed on the basis of the database and the physical amount varying depending on the distance. As a result, even when the gap is not more than ¼ of the measurement light source wavelength, the gap can be directly measured. Further, it is also possible to continuously measure the gap between the mold and the substrate in a range from nanometers to several tens of micrometers with high accuracy.

The processing apparatus described above is applicable to an imprint apparatus including a mold having a processing surface. The imprint apparatus employs a light imprint method in which a resin material cured by irradiation with ultraviolet rays or a thermal imprint method for performing pattern transfer onto the resin material under heating.

Hereinbelow, Examples of the present invention will be described.

### Embodiment 1

In Embodiment 1, a processing method using a mold to which the present invention is applied will be described.

FIG. 3 shows a constitution of a processing apparatus (imprint apparatus) used in the present invention.

In a coordinate system shown in FIG. 3, a plane parallel to a processing surface of the mold is taken as xy-plane and a direction perpendicular to the processing surface of the mold is taken as z-direction.

As described above, the processing apparatus is constituted by the exposure light source 101, the mold holding portion 102, the substrate holding portion 103, the substrate raising and lowering mechanism 104 (in z-direction), the in-plane moving mechanism 105 (in xy-plane), the imprint controlling mechanism 112, a gap measuring mechanism, etc.

The mold holding portion 102 effects chucking of the mold 113 by a vacuum chuck method or the like. The substrate 115 is movable to a desired position by the in-plane moving mechanism 105. The substrate raising and lowering mechanism 104 adjusts the position of the substrate 115 in z-direction, whereby it is possible to perform contact and pressure application between the mold 113 and the substrate 115.

Incidentally, a position of the substrate raising and lowering mechanism 104 in a height direction can be monitored by an encoder. Control of the position movement, pressure application, and light exposure with respect to the substrate 115 is effected by the imprint control mechanism 112.

Further, the processing apparatus also includes a detection system for effecting in-plane alignment (not shown).

The substrate 115 is disposed at a position opposite to the mold 113 and onto the substrate 115, the photocurable resin material 114 is applied. Incidentally, the photocurable resin material is applied by spin coating in this embodiment.

Next, the gap measuring mechanism in this embodiment will be described.

The gap measuring mechanism is principally constituted by the optical system 106, the measurement light source 107, the beam splitter 108, the spectroscope 109, the image pickup device 110, and the analyzing mechanism 111.

As the measurement light source 107, a light source which emits broadband light having a wavelength of, e.g., 400 nm-800 nm is used. Incidentally, in the case where several points of data are used as in Embodiment 2 described later, the light source 107 may also be an LED light source corresponding to the several points of data.

The light emitted from the measurement light source 107 passes through the optical system 106 to reach the mold 113, the photocurable resin material 114, and the substrate 115. The light interferes among the mold 113, the photocurable resin material 114, and the substrate 115. The interfering light is then returned to the optical system 106 to reach the spectroscope 109. The light dispersed by the spectroscope 109 is observed through the image pickup device 110.

The image pickup device 110 is constituted by a line sensor or the like having a sufficient resolution and a sufficient sensitivity.

The analyzing mechanism stores a database of spectra corresponding to gaps in advance and has the function of performing a search while comparing the database with data from the line sensor.

In this embodiment, the substrate raising and lowering mechanism is provided to the substrate side but may also be provided to the mold side or both of the substrate side and the mold side. In these cases, the substrate raising and lowering mechanism may also effect control with respect to six axes (x, y, z, α, β, θ).

Incidentally, by providing a plurality of gap measuring mechanisms, it is possible to control attitudes of the mold and the substrate with high accuracy.

Next, a gap measuring method for measuring a gap between the mold and the substrate in this embodiment will be described.

In this embodiment, the gap measuring method is performed by using an inverse problem method.

Herein, a problem that an output (gap) is obtained from an input (measured spectrum) is referred to as a “forward problem”, and a problem that the input is estimated from the output is referred to as an “inverse problem”.

In a conventional gap measuring method, a gap has been determined by detecting a peak corresponding to the gap from a spectrum by a Fourier transform method or the like.

In the gap measuring method in this embodiment, inputs (measured spectra) depending on outputs (gaps) are prepared in advance and a gap is estimated by locating data coincident with a measured spectrum.

This distance estimating method will be described with reference to FIG. 4.

FIG. 4(a) schematically shows a spectrum obtained by the line sensor when a gap between the mold and the substrate is a certain value.

An abscissa represents a wavelength ranging from 400 nm to 800 nm, and an ordinate represents an intensity of light.

FIG. 4(b) shows data stored in the database of the analyzing mechanism in advance, wherein 16 data for gaps from 10 nm to 1000 nm are shown.

In the database, data for performing estimation with sufficient accuracy are prepared. For example, when an accuracy of 10 nm is required, data in increments of 2 nm or the like are prepared in advance. The database may be created by calculation or data measured in advance. In the case of the calculation, a data table can be prepared by using, e.g., Fresnel reflection and its multiple reflection.

Incidentally, a light intensity and a refractive index of the light source depend on a wavelength, so that the calculation may also be performed in view of these factors. Further, in the case where the refractive index is changed by polarized light, a correction may be made.

In the database, data for the case of interposing only the resin material between the mold and the substrate, the case of interposing air and the resin material between the mold and the substrate, and the case of a substrate having a multi-layer (film) structure may be stored.

During the measurement, first, coincident data is located while the spectrum obtained by the line sensor is compared with the database.

For example, when the wavelength is taken as λ, the obtained spectrum can be represented by the following formula:

yₐ=f(λ)

Data at a gap d in the database can be represented by the following formula:

yᵣ=g_{d}(λ)

An example of a procedure for confirming whether or not the coincident data is present will be described.

At each of wavelengths from 400 nm to 800 nm, a root mean square value is obtained, after the spectrum obtained from data of the database is subtracted, in accordance with the following formula:

$$h ( d ) = \sqrt{\frac{1}{400} {\int }_{400}^{800} {\vert {g}_{d} ( λ ) - f ( λ ) \vert}^{2} d λ}$$

This value is a minimum, and a gap d when the value is smaller than a predetermined value is a desired value.

In some cases, the obtained spectrum is affected by a coefficient under the influence of light amount or the like or by offset with respect to data of the database.

In order to meet such cases, an operation for determining the coefficient and the offset may also be performed in advance.

For example, a coefficient A can be obtained by the following formula:

$$A = \frac{Max ( f ( λ ) ) - Min ( f ( λ ) )}{Max ( {g}_{d} ( λ ) ) - Min ( {g}_{d} ( λ ) )}$$

In the formula, Max(f(λ)) represents a maximum of f(λ) and Min(f(λ)) represents a minimum of f(λ).

When an average of f(λ) is represented by:

f̅(λ),

an offset B is represented by the following formula:

B= f̅(̅λ̅)̅−A g̅(̅λ̅)̅

The coefficient and offset substantially depend on a light amount and a reflectance in many cases, so that at least one calculation for obtaining the coefficient and the offset may be performed in these cases.

In this location of data, it is possible to reduce a time by performing the location of only data close to a gap currently estimated on the basis of a value of the encoder or the like. Particularly, in the imprint operation, the substrate raising and lowering mechanism is controlled with high accuracy so as to provide a desired residual film thickness in many cases, so that the above described inverse problem method is suitable.

In the case where there is the coincident data, the data is a spectrum generated when a specific gap is formed between the mold and the substrate, so that the gap between the mold and the substrate can be estimated. For example, in the case shown in FIG. 4(a), the gap can be estimated at 40 nm. Incidentally, the reason why the gap can be estimated uniquely is that materials for the mold, the substrate, and the resin material are specified, so that their optical constants or the like can be specified. However, in the case where the materials for the mold, the substrate, and the resin material are changed, the database can be prepared every time.

Next, a distance control procedure in this embodiment will be described.

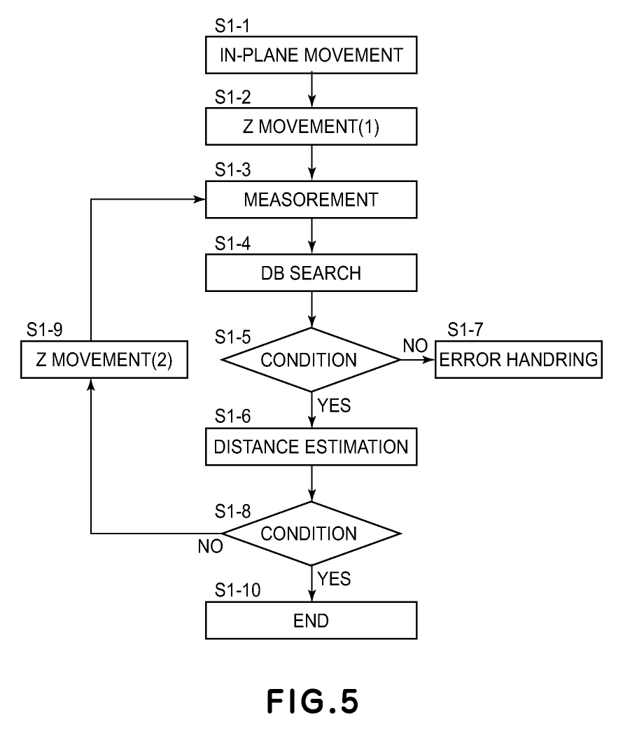

FIG. 5 is a flow chart for explaining the distance control procedure.

First, in step S1-1, the substrate is moved and disposed at a desired position opposite to the mold. At this time, positional alignment is performed by the in-plane moving mechanism.

Next, in step S1-2, the substrate is caused to come near to the mold surface by the substrate raising and lowering mechanism (Z movement (1)). The distance between the substrate and the mold at this time is on the order of micrometers.

In step S1-3, spectral measurement is performed to obtain a spectrum changing depending on the gap between the mold and the substrate.

In step S1-4, data coincident with the spectrum obtained in step S1-3 is located from the database (DB).

In step S1-5, the procedure is separated into two cases depending on whether or not there is data in the database coincident with the obtained spectrum.

In the case where there is the coincident data, the procedure goes to step S1-6 in which a gap corresponding to the coincident data is estimated to be a distance between the mold and the substrate.

In the case where there is no coincident data, in step S1-7, error handling such as remeasurement or the like is performed.

In step S1-8, the procedure is separated into two cases depending on whether or not the gap is a desired value.

In the case where the gap is not the desired value, the procedure goes to step S1-9 in which Z movement (2) is performed by the substrate raising and lowering mechanism.

In the case where the gap is the desired value, in step S1-10, the procedure is completed.

As described above, by controlling the gap between the mold and the substrate by means of the substrate raising and lowering mechanism while estimating the gap, it is possible to accurately control the residual film thickness.

In the case where there is a plurality of gap measuring mechanisms, these mechanisms may be controlled simultaneously or independently.

### Embodiment 2

In Embodiment 2, different from Embodiment 1, a capacity required for the database is considerably reduced.

For example, in the database in Embodiment 1, a substantially successive data divided into about 1000 points in a wavelength range from 400 nm to 800 nm with respect to a certain gap is stored. On the other hand, in this embodiment, with respect to the certain gap, a discrete data including several points may be used.

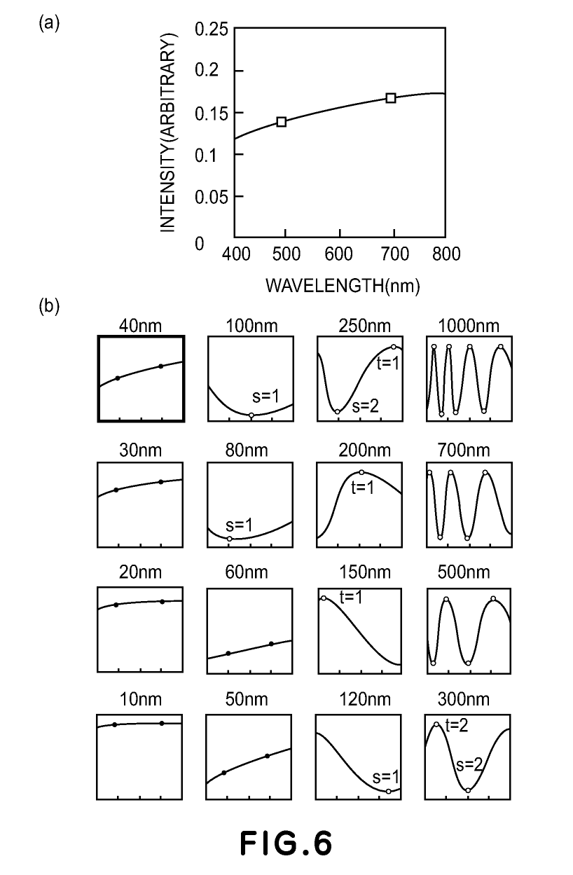

FIGS. 6(a) and 6(b) are schematic views for illustrating a distance estimating method in this embodiment.

FIG. 6(a) schematically illustrate an example of a spectrum obtained by the line sensor when a certain gap is formed between the mold and the substrate.

In FIG. 6(a), two points indicated by white square dots (□) are data at a wavelength of 500 nm and data at a wavelength of 700 nm, respectively.

FIG. 6(b) includes 16 data for gaps from 10 nm to 1000 nm as a part of the database, wherein an abscissa represents a wavelength and an ordinate represents a light intensity. Values outside the respective graphs are gap lengths.

In the database, data for performing estimation with sufficient accuracy is prepared. In FIG. 6(b), points indicated by white dots (◯) represent extreme values such as a maximum value and a minimum value. Further, points indicated by black dots () are reference point data of light intensity at a wavelength of 500 nm or 700 nm in the case where there is no extreme value.

Even in the case of no extreme value, when the gap is gradually decreased at a wavelength of not more than ¼ of the light source wavelength for measurement, data of the light intensity is monotonically increased. For this reason, the gap can be specified.

Incidentally, in the case shown in FIG. 6(a), the gap can be estimated at 40 nm. In FIG. 6(a), a line passing through the two square dots represents reference data shown in FIG. 4(a). However, data actually stored in a storing device is data including several points indicated by the white dots (◯) and the black dots () in the respective gaps.

Next, a distance control procedure in this embodiment will be described.

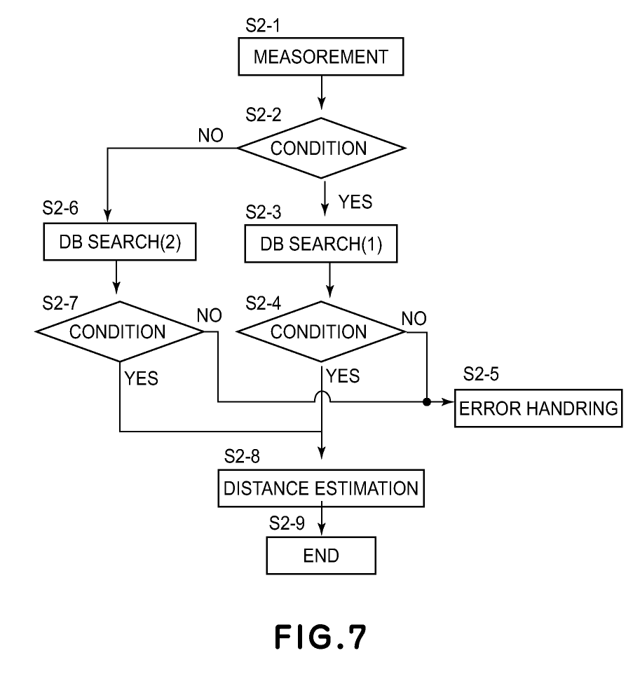

FIG. 7 is a flow chart for illustrating the distance control procedure.

First, in step S2-1, measurement is performed.

Next, in step S2-2, a judgment as to whether or not the obtained spectrum has an extreme value is made. In the case where the spectrum has the extreme value, the procedure goes to step S2-3. In the case where the spectrum has no extreme value, the procedure goes to step S2-6.

In step S203, data location is made by using a wavelength and light intensity for the extreme value as keys (DB search (1)).

Next, in step S2-4, a judgment as to whether or not there is coincident data is made. In the case where there is the coincident data, the procedure goes to step S2-8. In the case where there is no coincident data, in step S2-5, error handling such as remeasurement or the like is performed.

When the procedure goes to step S2-6, data location (DB search (2)) is performed by using obtained reference point data at wavelengths of 500 nm and 700 nm as keys.

In step S2-7, a judgment as to whether or not there is a coincident data is made. In the case where there is the coincident data, the procedure goes to step S2-8 in which a gap with respect to the coincident data can be estimated to be a distance between the mold and the substrate. In the case of no coincident data, in step S2-5, the error handling is performed.

Further, it is also possible to use the successive data as in Embodiment 1 and the discrete data as in Embodiment 2 in combination.

In the case where data in the database has an increment of 10 nm and data with an increment smaller than 10 nm is not stored, it is possible to estimate a further accurate value.

When there is no extreme value and measured data at a wavelength of 500 nm is 0.2 (intensity), coincident data based on an algorithm is data for the gap of 30 nm (intensity: 0.196) shown in FIG. 6(b). Alternatively, the gap may also be estimated at 28.6 nm by linear interpolation between the intensity data (0.196) for 30 nm and intensity data (0.225) for 20 nm.

The case where there are extreme values is further considered.

A gap d can be represented by formulas shown below when a wavelength at a minimum value is λₘᵢₙ, a wavelength at a maximum value is λₘₐₓ, a refractive index is n, and integers s and t are used.

$$d = \frac{2 s - 1}{4 n} {λ}_{min} , s = 1 , 2 , 3 , Λ$$

$$d = \frac{t}{2 n} {λ}_{max} , t = 1 , 2 , 3 , Λ$$

Several values of the integers s and t are shown in FIG. 6(b) as extreme values.

Accordingly, from the number of the extreme values of measured spectra and their wavelengths, it is possible to obtain a gap.

Particularly, in the case of obtaining an approximate value of the gap, it is possible to effect high-speed processing.

For example, when the measured spectrum has one extreme value (minimum value) at a wavelength between 500 nm and 600 nm, a gap can be estimated at a value between 80 nm and 100 nm. In this case, s=1, so that it is possible to measure a desired gap by substitution of a wavelength at the minimum value. Incidentally, also in the case where there is the extreme value, the gap may be estimated from reference data of light intensity at a specific wavelength. Further, in the case where data for a gap coincides with data for another gap, gap measurement can be effected by increasing the number of reference points.

In the present invention, the reference point data may be not only the light intensity but also a slope or the like of an intensity curve. Further, the extreme value may also be an infection point or the like.

### INDUSTRIAL APPLICABILITY

The gap measuring method, imprint method, and imprint apparatus according to the present invention described above are applicable to a semiconductor fabrication technology and production technologies of optical devices such as photonic crystal and of biochips such as μ-TAS.

1. A gap measuring method for measuring a gap between two members by irradiating the two members with light, said gap measuring method comprising:
preparing a first member and a second member which are disposed opposite to each other;
irradiating the first member and the second member with light from one member side to obtain spectral data about intensity of reflected light or transmitted light from the other member side; and
determining a gap between the first member and the second member by comparing the obtained spectral data with a database in which a gap length and an intensity spectrum are correlated with each other.

2. A method according to claim 1, wherein the first member and the second member are disposed with a gap smaller than ¼ of a wavelength of the irradiation light.

3. An imprint method for forming a pattern by interposing a pattern forming material between two members and curing the pattern forming material, said imprint method comprising:
preparing a first member having an imprint pattern at a surface thereof;
preparing a second member disposed opposite to the first member;
measuring a gap between the first member and the second member by said gap measuring method according to claim 1 or 2;
decreasing the gap between the first member and the second member until a difference between a gap length measured by said gap measuring method and a preset gap length is within an acceptable error range; and
curing the pattern forming material interposed between the first member and the second member in a state in which the difference between the gap length measured by said gap measuring method and the preset gap length is within the acceptable error range.

4. An imprint apparatus for transferring a pattern formed on a processing surface of a mold onto a member to be processed, said imprint apparatus comprising:
physical amount measuring means for measuring a physical amount varying depending on a distance between the mold and the member to be processed; and
distance estimating means for estimating the distance between the mold and the member to be processed by comparing the measured physical amount with data preliminarily stored in a database.

5. An apparatus according to claim 4, wherein said physical amount measuring means comprises a measuring light source for measuring light intensity spectra from the mold and the member to be processed.

6. An apparatus according to claim 4 or 5, wherein said physical amount measuring means comprises database storing means for preliminarily storing a database containing data about measurement spectra depending on the distance between the mold and the member to be processed.

7. An apparatus according to claim 4 or 5, wherein said imprint apparatus further comprises attitude control means for controlling an attitude of the mold and/or the member to be processed on the basis of a result of the distance estimation by said distance estimating means.

8. An apparatus according to claim 6, wherein said imprint apparatus further comprises attitude control means for controlling an attitude of the mold and/or the member to be processed on the basis of a result of the distance estimation by said distance estimating means.
